(19) United States
(12) Patent Application Publication
(10) Pub. No.: US 2018/0048205 A1
(43) Pub. Date: Feb. 15, 2018

(54) INSULATION WIRE, ROTARY ELECTRIC MACHINE, AND MANUFACTURING METHOD OF INSULATION WIRE

(71) Applicant: HITACHI METALS, LTD., Tokyo (JP)

(72) Inventors: Shintaro TAKEDA, Tokyo (JP); Yoshiaki OKABE, Tokyo (JP)

(73) Assignee: HITACHI METALS, LTD., Tokyo (JP)

(21) Appl. No.: 15/671,627

(22) Filed: Aug. 8, 2017

(30) Foreign Application Priority Data
Aug. 9, 2016 (JP) 2016-157015

(51) Int. Cl. H02K 3/30; H01B 13/14; H01B 7/02

(52) U.S. Cl. CPC H02K 3/30; H01B 7/0216; H01B 13/145; H01B 13/148; H01B 3/305

(57) ABSTRACT

An insulation wire 10 according to the invention includes: a conductor 11 of any shape; an insulation film 12 made of a first thermoplastic resin that is formed around the conductor 11; and a self-bonding layer 13 made of a second thermoplastic resin that is formed around the insulation film 12 and has a self-bonding property, wherein the first thermoplastic resin contains at least one of polyphenylene sulfide and polyether ether ketone, and wherein the second thermoplastic resin contains a thermosetting resin and an inorganic filler.

### BACKGROUND OF THE INVENTION

### 1. Field of the Invention

The present invention relates to an insulation wire, a rotary electric machine, and a manufacturing method of the insulation wire.

### 2. Description of the Related Art

Presently, a miniaturization and an increasing output power of a rotary electric machine such as a driving motor which is used in household electric machines, industry electric machines, ships, railway vehicles, and electric vehicles are ongoing. Therefore, heat resistance tolerable against the increased heating caused along with the miniaturization and the increasing output power, and pressure resistance (voltage resistance) tolerable against an increasing voltage are requested for an insulation wire used as a winding of the rotary electric machine.

Conventionally, as a winding of the rotary electric machine, there is primarily used an enameled wire which is formed by coating and baking varnish obtained by dissolving an insulating resin into a solvent. For example, the enameled wire manufactured by coating and baking polyimide varnish belongs to the H or higher class in heat resistance, and has heat resistance and an insulation property enduring a high temperature environment for a long time.

However, a process of coating and baking the varnish is necessarily repeated many times in order to form a predetermined film thickness of the insulation film in such an enameled wire. In addition, the processes have a problem in that the solvent contained in the varnish is left out as a waste in every process. The number of processes of coating and baking the varnish is increased in order to obtain higher voltage resistance, so that the cost is increased.

Therefore, as a method of manufacturing the insulation wire, there is considered a method of manufacturing the wire in which a thermoplastic resin is employed as the insulating resin for forming the insulation film by using an extrusion molding without the solvent. It is considered that the method reduces an environmental load and also effective. Further, in the extrusion molding, it is necessary that the thermoplastic resin be heated to a glass transition temperature or higher and be dissolved to be a viscosity suitable to the molding.

A super engineering plastic (such as polyphenylene sulfide (PPS) or polyether ether ketone (PEEK)) and a resin alloy thereof are known as the thermoplastic resin belonging to the H-class heat resistance. These materials are chemically stable compared to the conventional thermoplastic resin, and JP-2013-33607-A and JP-04-073811-A disclose examples that these materials are applied to the insulation wire.

JP-2013-33607-A discloses an insulation wire which is provided with at least one of the PPS and the PEEK and polyethylene around a conductor, and includes a coating layer having an insulation property with a storage elastic modulus in a predetermined range. In addition, JP-04-073811-A discloses a self-fusing insulation wire which includes an outermost self-bonding layer and an inner insulating layer made of the PPS.

The techniques disclosed in JP-2013-33607-A and JP-04-073811-A can form arbitrarily the insulation film by a small number of processes compared to the enameled wire, and can provide the insulation wire having the heat resistance and the pressure resistance. In addition, a resin thin film (layer) made of the super engineering plastic such as the PPS or the PEEK disclosed in JP-2013-33607-A and JP-04-073811-A is formed around the conductor by the extrusion molding. The insulation wire thus manufactured is provided from a wire maker to a maker which produces a rotary electric machine.

In general, the rotary electric machine is configured to include a rotor and a stator, and a coil obtained by winding the insulation wire is provided in any one of them. The rotary electric machine generates a rotation force using an induction field caused by the current flowing to the coil so as to rotate the rotor. A centrifugal force, vibrations, and an electromagnetic force are applied to the winding provided in the rotor or the stator as the rotor rotates.

The windings rub each other by such a mechanical stress, and the windings rub a surrounding member. Therefore, in order to prevent the insulation film of the winding from being worn out, the maker of the rotary electric machine generally performs a fixing process on the coil using a resin varnish having a thermosetting property such as an epoxy resin and an unsaturated polyester resin.

The resin varnish used in the fixing process is used in a highly polarized liquid state in which an epoxy resin and an unsaturated polyester resin are dissolved. On one hand, the PPS or the PEEK is chemically stable, but on the other hand, it is low in affinity. Therefore, the PPS or the PEEK has a problem of a low wettability to an organic solvent, and the insulation wire formed with the PPS or the PEEK in the outermost layer also has a low wettability of the resin varnish.

When the wettability of the resin varnish is low with respect to the insulation wire, the resin varnish is also low in permeability between the insulation wires or and between the insulation wire and a surrounding member. Therefore, there is a concern that a fixing process of the coil after curing the resin varnish is not sufficient, or a long-term reliability in driving the rotary electric machine is degraded. From this point of view, the insulation wire is provided by molding the self-bonding layer in the outermost layer of the PPS without using the fixing process in the resin varnish in JP-04-073811-A.

### SUMMARY OF THE INVENTION

The insulation wires disclosed in JP-2013-33607-A and JP-04-073811-A are produced such that the insulation film is peeled off by an arbitrary length from the end to expose the conductor after being processed into the coil, and the exposed end is connected to a power source or a peripheral circuit by welding. At this time, heat caused by welding is transferred through the conductor, and the insulation film (such as the PPS or the PEEK) and the self-bonding layer are heated. When the heat is transferred to the insulation film such as the PPS or the PEEK, the insulation film is lifted up and peeled from the conductor (hereinafter, referred to as “lifting-up and peeling”). In addition, in a case where the self-bonding layer is formed by a thermoplastic resin such as polyester and a phenoxy resin, there is a problem in that the self-bonding layer is melt and peeled off from the insulation film, or a layer thickness is uneven when the welding heat transferred through the conductor exceeds a glass transition temperature or a melting point of the resin. In addition, in a case where a thermosetting resin is used as a coating film of the conductor, the curing is progressed by the welding heat transferred through the conductor, but the self-bonding layer is melt when the temperature exceeds a monomer melting point. Therefore, the same peeling problem occurs.

Further, in the case of the rotary electric machine in which the insulation wire is bent near the end of the welding of the insulation wire obtained by processing the coil, a stress occurs due to the bending in a place where the bending is performed. When the welding heat is transferred through the conductor and reaches the place where the stress occurs, cracks are generated in the insulation film, and the insulation Property may be lowered.

The invention has been made in view of such a situation, and an object thereof is to provide an insulation wire, a rotary electric machine, and a manufacturing method of the insulation wire in which the insulation film is not subjected to the lifting-up and peeling even when the heat caused by welding is transferred through the conductor, and an insulation property is secured.

An insulation wire according to the invention for solving the problem includes: a conductor of any shape; an insulation film made of a first thermoplastic resin that is formed around the conductor; and a self-bonding layer made of a second thermoplastic resin that is formed around the insulation film and has a self-bonding property, wherein the first thermoplastic resin contains at least one of polyphenylene sulfide and polyether ether ketone, and wherein the second thermoplastic resin contains a thermosetting resin and an inorganic filler.

In addition, a rotary electric machine according to the invention includes: an insulation wire that includes a conductor of any shape, an insulation film made of a first thermoplastic resin that is formed around the conductor, and a self-bonding layer made of a second thermoplastic resin that is formed around the insulation film and has a self-bonding property, wherein the first thermoplastic resin contains at least one of polyphenylene sulfide and polyether ether ketone, and wherein the second thermoplastic resin contains a thermosetting resin and an inorganic filler; and a rotor or a stator to which the insulation wire is wound.

A manufacturing method of an insulation wire according to the invention is a manufacturing method of an insulation wire that includes a conductor of any shape, an insulation film made of a first thermoplastic resin that is formed around the conductor, and a self-bonding layer made of a second thermoplastic resin that is formed around the insulation film and has a self-bonding property, wherein the first thermoplastic resin contains at least one of polyphenylene sulfide and polyether ether ketone, and wherein the second thermoplastic resin contains a thermosetting resin and an inorganic filler, and the method includes: forming the insulation film around the conductor made of any shape by an extrusion molding; and forming the self-bonding layer around the insulation film.

According to the invention, it is possible to provide an insulation wire and a rotary electric machine in which an insulation film is not lifted up nor peeled, and an insulation property can be secured even when heat caused by welding is transferred through a conductor. The manufacturing method of the insulation wire according to the invention can manufacture the insulation wire in which the insulation film is not lifted up and peeled, and the insulation property can be secured even when the heat caused by welding is transferred the conductor.

### BRIEF DESCRIPTION OF THE DRAWINGS

FIG. 1 is a schematic cross-sectional view for describing a configuration of an insulation wire according to an embodiment;

FIG. 2 is a schematic cross-sectional view for describing a configuration of the insulation wire according to an embodiment;

FIG. 3 is a schematic cross-sectional view illustrating a state where part of a conductor is cut out together with an insulation film and the self-bonding layer from the end of the insulation wire using a tool so as to expose the conductor;

FIG. 4 is a schematic cross-sectional view for describing a state after the end of the exposed conductor is heated at a temperature as high as welding;

FIG. 5 is a schematic exploded view for describing an aspect of a rotary electric machine according to this embodiment;

FIG. 6 is a schematic cross-sectional view for describing a coil which is obtained by winding an insulation wire according to this embodiment around a stator illustrated in FIG. 5;

FIG. 7 is a schematic exploded view for describing another aspect of the rotary electric machine according to this embodiment;

FIG. 8 is a schematic cross-sectional view for describing the coil which is obtained by winding the insulation wire according to this embodiment around the stator illustrated in FIG. 7;

FIG. 9 is a flowchart for describing a manufacturing method of the insulation wire according to this embodiment;

FIG. 10 is a schematic view illustrating a configuration of a manufacturing apparatus which implements the manufacturing method of the insulation wire according to this embodiment;

FIG. 11 is a schematic view for describing a test piece for simulating a welding portion of the insulation wire according to the example and the comparative example; and

FIG. 12 is a schematic view for describing a test piece for simulating the welding portion of the insulation wire according to the example and the comparative example.

### DESCRIPTION OF THE PREFERRED EMBODIMENTS

Hereinafter, embodiments of an insulation wire and a rotary electric machine according to the invention will be appropriately described in detail with reference to the drawings.

### (Insulation Wire)

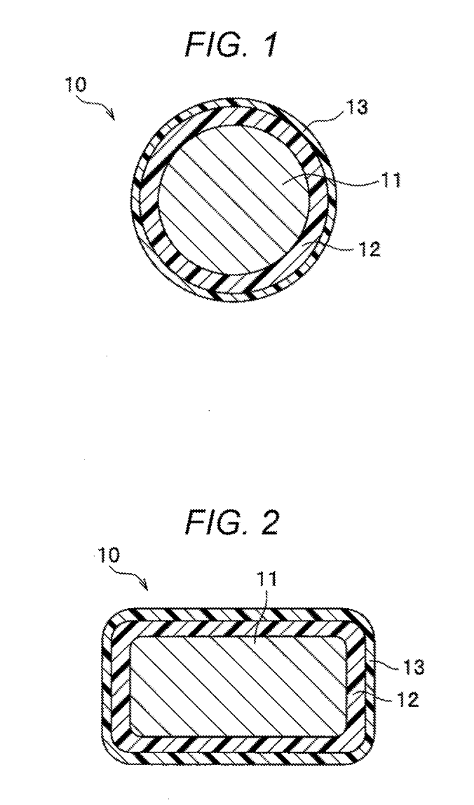

FIGS. 1 and 2 are schematic cross-sectional views for describing the configuration of an insulation wire 10 according to an embodiment. As illustrated in FIGS. 1 and 2, the insulation wire 10 according to this embodiment includes a conductor 11, an insulation film 12 which is formed around the conductor 11, and a self-bonding layer 13 which is formed around the insulation film 12. The insulation wire 10 according to this embodiment can be applied to a rotary electric machine such as a driving motor which is used in household electric machines, industry electric machines, ships, railway vehicles, and electric vehicles, but not limited thereto. The insulation wire may be applied to any machine as long as a conventional enameled wire can be used to the machine. In other words, the insulation wire 10 according to this embodiment may be used in place of the enameled wire.

### (Conductor)

The conductor 11 may have any shape. The conductor 11 may use, for example, the conductor 11 having the same wire shape as that of a core wire of the typical insulation wire 10, or may be formed by a copper wire, an aluminium wire, or an alloy wire made of an alloy containing at least one of copper and aluminium. As a copper wire, any one of tough pitch copper, oxygen free copper, and deoxidized copper may be used, or any one of an annealed copper wire and a hard-drawn copper wire may be used. In addition, a wire of which the surface is plated with tin, nickel, silver, or aluminium may be used. As an aluminium wire, a hard-drawn aluminium wire and a semihard-drawn aluminium wire may be used. In addition, as an alloy wire, for example, there may be exemplified a wire formed of a copper-tin alloy, a copper-silver alloy, a copper-zinc alloy, a copper-chromium alloy, a copper-zirconium alloy, an aluminium-copper alloy, an aluminium-silver alloy, an aluminium-zinc alloy, an aluminium-iron alloy, or an aldrey aluminium alloy.

The shape of the conductor 11 is desirably a circular wire of which the horizontal cross section is a circulate shape as illustrated in FIG. 1 for example, and may be a rectangular wire of which the horizontal cross section is a rectangular shape as illustrated in FIG. 2. Further, the rectangular wire may have rounded corners. In addition, a single wire formed by one conductor 11 and a strand wire formed by twisting a plurality of conductors 11 may be used. The conductor 11 is desirably subjected to a surface treatment using an organometallic compound such as a silane coupling agent in order to improve adhesiveness to a first thermoplastic resin. The conductor 11 may be manufactured such that a raw material is dissolved to mold an ingot such as a billet or a wire bar, and the ingot may be molded by an extruding process or by an extending process after hot rolling is performed. Further, the conductor 11 may be replaced with one which currently comes into the market.

### (Insulation Film)

The insulation film 12 is formed around the conductor 11 using the first thermoplastic resin. The first thermoplastic resin is made of any one of polyphenylene sulfide (PPS) and polyether ether ketone (PEEK). In other words, with the use of the PPS or the PEEK, the insulation film 12 becomes excellent in an insulation property, heat resistance, chemical resistance, fire retardance, dimension stability, and a mechanical property.

The first thermoplastic resin may be a resin alloy to which other resin material and inorganic material are added to the PPS or the PEEK according to required characteristics such as workability, the heat resistance, and the insulation property. As the other resin material and the inorganic material, for example, a thermoplastic resin such as polyamide or thermoplastic polyimide, an inorganic filler such as talc, and a glass fiber may be exemplified. In addition, the PPS or the PEEK may be a modified PPS or a modified PEEK which is partially deformed. Examples of the PPS may include Torelina (registered trademark) T1881 (made by Toray). An arbitrary amount of other resins may be added as needed, and adjusted by kneading. A layer thickness of the insulation film 12 can be arbitrarily selected in consideration of the insulation property and the workability, but it may be desirably equal to 100 μm or more and 200 μm or less in a trend of high output and miniaturization of the rotary electric machine in recent years.

### (Self-Bonding Layer)

The self-bonding layer 13 is formed around the insulation film 12. The self-bonding layer 13 is formed using a second thermoplastic resin, and has a self-bonding property. In other words, when being activated by heat or solvent, the self-bonding layer 13 is fused with the adjacent self-bonding layer 13, and forms a larger structure. For example, a winding coil produced by winding the insulation wire 10 around magnetic pole teeth of the rotary electric machine may be used as a coil produced by self-fusing one fusion coil (that is, the self-bonding layer 13 of the winding coil). The second thermoplastic resin contains a thermosetting resin (a thermosetting monomer and a cross-linking agent) and an inorganic filler. In addition, the self-bonding layer 13 contains a curing agent.

The second thermoplastic resin contains at least one of a phenoxy resin and a polyamide resin, and these resins may be mixed together at an arbitrary ratio. In other words, a mixing ratio of the phenoxy resin and the polyamide resin as the second thermoplastic resin may be set such that the polyamide resin becomes 100 to 0 parts by weight with respect to 0 to 100 parts by weight of the phenoxy resin. Preferably, for example, the polyamide resin is set to 20 or more parts by weight with respect to a total 100 parts by weight of the phenoxy resin and the polyamide resin, and more preferably, the polyamide resin is set to 40 or more parts by weight with respect to a total 100 parts by weight of the phenoxy resin and the polyamide resin.

As an example of the phenoxy resin, YP-70 or ZX-1356-2 (a copolymer made of a bisphenol A epoxy resin and bisphenol F epoxy resin) made by Nippon Steel & Sumikin Chemical Co., Ltd. may be used. In addition, as an example of the phenoxy resin, YP-50 or FX-316 (a bisphenol A phenoxy resin and a bisphenol F phenoxy resin) by Nippon Steel & Sumikin Chemical Co., Ltd. may be used. As an example of the polyamide resin, CM3007 (PA66 excellent in flexibility) made by Toray and UBESTA XPA (registered trademark) made by Ube Industries, Ltd. may be used, and a resin composition produced by blending these resins into the phenoxy resin at an arbitrary ratio may be used.

For example, an epoxy compound may be suitably used as the thermosetting monomer. A content of the thermosetting monomer may be appropriately set and, for example, desirably 5 or more parts by weight and 30 or less parts by weight with respect to 100 parts by weight of the second thermoplastic resin. The epoxy compound may be, for example, produced by mixing one or two or more resins selected from an aromatic epoxy resin, an alicyclic epoxy resin, a novolac epoxy resin, an aliphatic epoxy resin, a glycidyl ester type epoxy resin, a glycidyl amine type epoxy resin, a glycidyl acrylic type epoxy resin, a bisphenol A type epoxy resin, a bisphenol F type epoxy resin, and a polyester type epoxy resin. As the epoxy compound, it is desirable to use a multifunctional epoxy resin which can increase a cross-linking density in a case where an adhesive strength is improved and heat resistance is increased.

The curing agent is also called the cross-linking agent, and serves to cure (cross-link) the thermosetting monomer. A composition of the second thermoplastic resin desirably contains a curing catalyst which accelerates a reaction between the thermosetting monomer and the curing catalyst at an arbitrary ratio. A content of the curing agent can be appropriately set in accordance with an equivalent ratio of the cross-linking agent and, for example, desirably 5 or more parts by weight and 30 or less parts by weight with respect to 100 parts by weight of the second thermoplastic resin. As the curing agent, a phenol resin or an acid anhydride can be used for example. As the phenol resin, a phenol aralkyl resin (having a phenol skeleton, or a dephenylene skeleton), a naphthol aralkyl resin, and a polyoxystyrene resin may be used for example. In addition, as the phenol resin, a resol type phenol resin such as an aniline modified resol resin, a demethyl ether resol resin, a novolac type phenol resin such as a phenol novolac resin, a cresol novolac resin, a tert-butyl phenol novolac resin, and a nonyl phenol novolac resin, and a specific phenol resin such as a dicyclopentadiene modified phenol resin, a terpene modified phenol resin, and a triphenolmethane type resin may be used for example. In addition, as a polyoxystyrene resin, a poly (p-oxystyrene) phenol novolac-based resin may be used. As the acid anhydride, a tetrahydro phthalic anhydride and a hexahydro phthalic anhydride may be used for example.

As the curing catalyst, for example, in a case where the self-bonding layer 13 is subjected to the extrusion molding, a high temperature type of imidazoles are desirably used which do not progress in a cross-linking reaction by the extrusion molding. The content of the curing catalyst can be appropriately set and, for example, desirably 0.1 or more parts by weight and 5 or less parts by weight with respect to 100 parts by weight of the second thermoplastic resin.

Since the self-bonding layer 13 contains the inorganic filler (not illustrated), the pressure resistance and the insulation property of a place to be bent in the insulation wire 10 can be improved. In addition, since the self-bonding layer 13 contains the inorganic filler, thixotropy can be obtained, and it is possible to suppress deformation and sagging at the time of thermal curing.

The inorganic filler is desirably formed in at least one of a plate shape and a squamous shape. Therefore, the pressure resistance and the insulation property are more securely improved, and the deformation at the time of thermal curing and the thermal sagging caused by heat transferred at the time of welding can be more securely suppressed. As the inorganic filler, any material may be used as long as the material is an inorganic material such as mica, glass flake, and aluminium hydroxide for example. As the inorganic filler, glass flake made by Nippon Sheet Glass Co., Ltd. and mica made by Yamaguchi Mica Co., Ltd. may be used for example. The content of the inorganic filler is not particularly limited as long as the workability and the insulation property are satisfied, and roughly 10 or more parts by weight and 30 or less parts by weight are practical.

A layer thickness of the self-bonding layer 13 is not Particularly limited as long as the adhesiveness between the insulation wires 10, the adhesiveness between the insulation wire 10 and the other member (not illustrated), and the adhesiveness between the insulation wire 10 and insulating varnish are obtained by the fusion, and desirably roughly 5 μm or more and 50 μm or less.

In addition, the insulation wire 10 according to this embodiment desirably is subjected to atmospheric pressure plasma treatment after the insulation film 12 is formed, and then the self-bonding layer 13 is formed. By performing the atmospheric pressure plasma treatment, the wettability of the insulation film 12 is improved, and the adhesiveness to the self-bonding layer 13 can be improved.

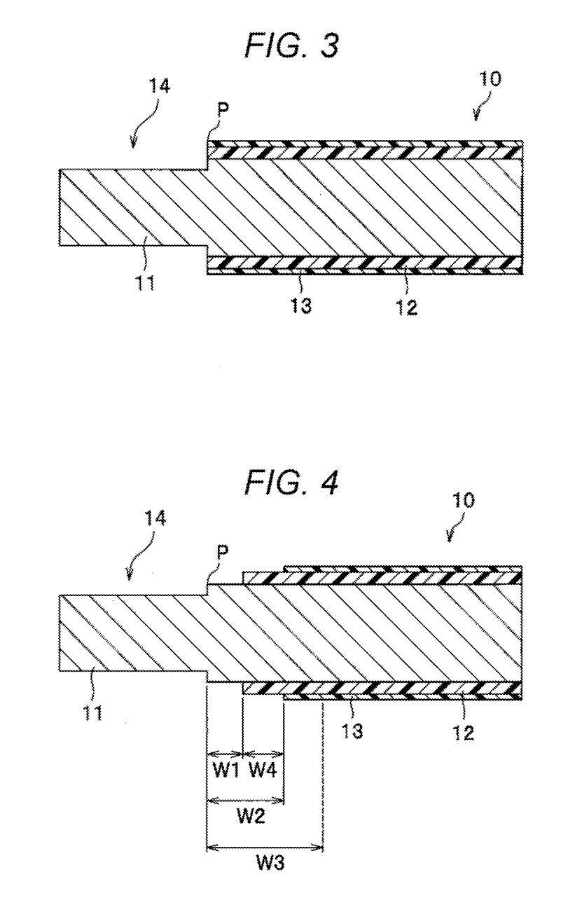

Further, the effect of improving the adhesiveness between the insulation film 12 and the self-bonding layer 13 obtained by the atmospheric pressure plasma treatment is vanished within a period from several hours to several days. Therefore, it can be said that it is not possible to determine whether the process is performed through analysis on the surface of the insulation film 12 of the insulation wire 10 using an analysis machine after the wire is commercialized and some periods elapse. However, a reference of whether the process is performed may be determined as follows. For example, part of the conductor 11 is cut out together with the insulation film 12 and the self-bonding layer 13 from the end of the insulation wire 10 using a tool such as an electric wire stripper so as to expose the conductor 11 (see FIG. 3, and FIG. 3 will be described below). Then, it is possible to make a determination by observing the presence/absence of the lifting-up and peeling of the insulation film 12 after the exposed conductor 11 is welded on a condition that the insulation film 12 and the self-bonding layer 13 are not carbonized. In this case, when the atmospheric pressure plasma treatment is performed, the adhesiveness between the insulation film 12 and the self-bonding layer 13 is improved, and the insulation film 12 is coated with the self-bonding layer 13, so that the lifting-up and peeling does not occur (mostly). On the contrary, in a case where the atmospheric pressure plasma treatment is not performed, the adhesiveness between the insulation film 12 and the self-bonding layer 13 is not improved, so that the self-bonding layer 13 is shrunk more than the insulation film 12. Therefore, an uncoated portion of the insulation film 12 is increased, and the lifting-up and peeling occurs. In other words, whether the atmospheric pressure plasma treatment is performed can be determined in this embodiment by performing such an observation test.

As described above, the self-bonding layer 13 is activated by heat and solvent and thus shows the self-bonding property. In other words, the self-bonding layer 13 of the unwelded insulation wire 10 contains an uncured thermosetting monomer (not used in the self-bonding). Therefore, when the heat caused by welding is transferred through the conductor 11 to heat the self-bonding layer 13, the self-bonding layer 13 is activated by the heat, and the resin is cured and shrunk. On the contrary, since the insulation film 12 does not contain the thermosetting monomer, the curing and shrinking of the resin caused by the thermosetting monomer does not occur. Therefore, a thermal shrinkage of the insulation film 12 is smaller than that of the self-bonding layer 13, and the insulation film 12 is hardly shrunk. Further, in the case of the insulation wire 10 according to this embodiment, the self-bonding layer 13 contains the inorganic filler, so that the curing and shrinking is reduced compared to the self-bonding layer which does not contain the inorganic filler. Furthermore, in the case of the insulation wire 10 according to this embodiment, when the surface of the insulation film 12 is subjected to the surface treatment such as the atmospheric pressure plasma treatment to increase the adhesive strength of the self-bonding layer 13, the adhesiveness between the insulation film 12 and the self-bonding layer 13 can be improved. Therefore, the curing and shrinking of the self-bonding layer 13 can be reduced still more.

Accordingly, when the welding is performed using the insulation wire 10 according to this embodiment and the rotary electric machine is manufactured, the insulation film 12 and the self-bonding layer 13 enter the states as illustrated in FIGS. 3 and 4. Further, FIG. 3 is a schematic cross-sectional view for describing a state where part of the conductor 11 is cut out together with the insulation film 12 and the self-bonding layer 13 from the end of the insulation wire 10 using a tool (not illustrated) so as to expose the conductor 11. FIG. 4 is a schematic cross-sectional view for describing a state after the end of the exposed conductor 11 is heated at a temperature as high as the welding.

First, as illustrated in FIG. 3, part of the conductor 11 is cut out together with the insulation film 12 and the self-bonding layer 13 from the end of the insulation wire 10 using a tool such as an electric wire stripper so as to expose the conductor 11. Therefore, a diameter of the exposed portion of the conductor 11 becomes narrow. In addition, at this time, the ends of the insulation film 12 and the self-bonding layer 13 are placed at the same position P. Next, when the exposed conductor 11 is welded, the insulation film 12 and the self-bonding layer 13 are shrunk by the heat as illustrated in FIG. 4. However, as described above, the insulation film 12 is hardly shrunk since the thermosetting monomer is not contained. In addition, since the self-bonding layer 13 contains the inorganic filler in this embodiment, the shrinkage can be reduced more than the self-bonding layer which does not contain the inorganic filler. Further, since the self-bonding layer 13 in this embodiment contains the inorganic filler, the insulation property is improved, and the thermal sagging can also be suppressed.

Therefore, when the welding is performed using the insulation wire 10 according to this embodiment, the welding portion is formed such that a difference between a distance (a distance where the conductor 11 is exposed) W1 from the position P where the insulation film 12 and the self-bonding layer 13 are removed before welding to the end of the insulation film 12 after welding, and a distance W2 from the position P where the insulation film 12 and the self-bonding layer 13 are removed before welding to the end of the self-bonding layer 13 after welding is reduced as illustrated in FIG. 4. In other words, even when the insulation wire 10 according to this embodiment is welded, the self-bonding layer 13 can coat the insulation film 12. Further, in the case of the self-bonding layer which does not contain the inorganic filler, a distance W3 (illustrated by a broken line in FIG. 4) from the position P where the insulation film is removed before welding to the end of the self-bonding layer after welding is increased more than the distance W2. In other words, in this case, the self-bonding layer cannot coat the insulation film when the welding is performed. Therefore, the lifting-up and peeling occur, and the insulation property cannot be secured.

As described above, when the welding is performed using the insulation wire 10 according to this embodiment, the insulation film 12 and the self-bonding layer 13 are hardly shrunk in a connection point of the welding between the insulation wires 10 or the welding to another conductive member. Therefore, the insulation property can be improved. In addition, since the insulation film 12 is coated with the self-bonding layer 13 which contains the inorganic filler, the lifting-up and peeling of the insulation film 12 can be prevented even when the welding heat is transferred through the conductor 11. Further, in a case where there is a bent place in the insulation wire 10, the pressure resistance and the insulation property of the bent place can be improved since the insulation film 12 is coated with the self-bonding layer 13 which contains the inorganic filler.

### (Rotary Electric Machine)

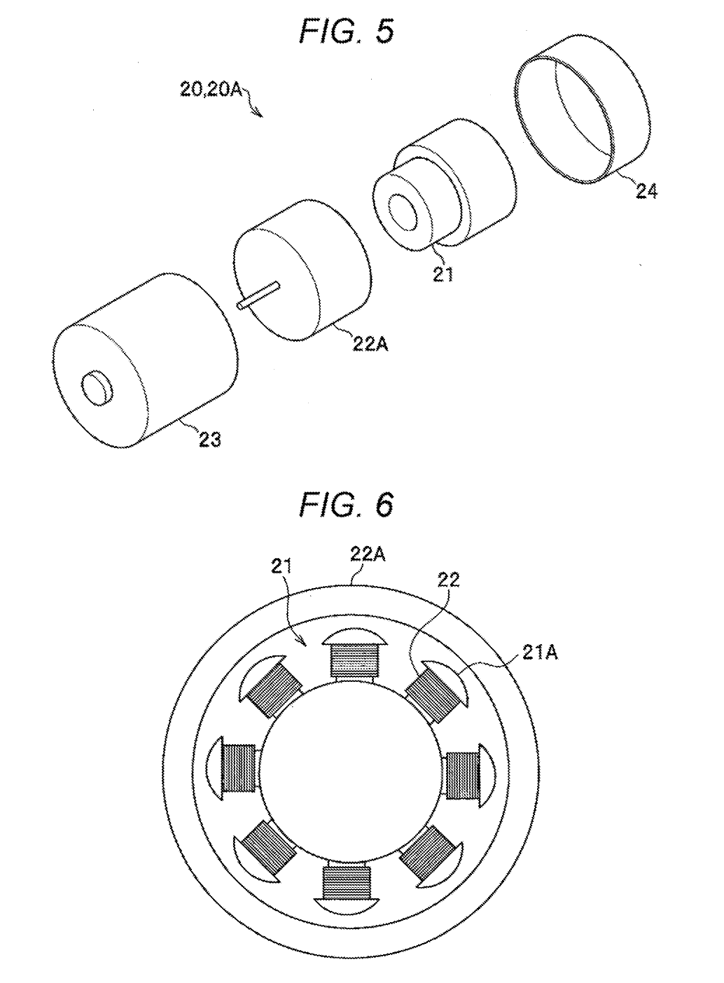

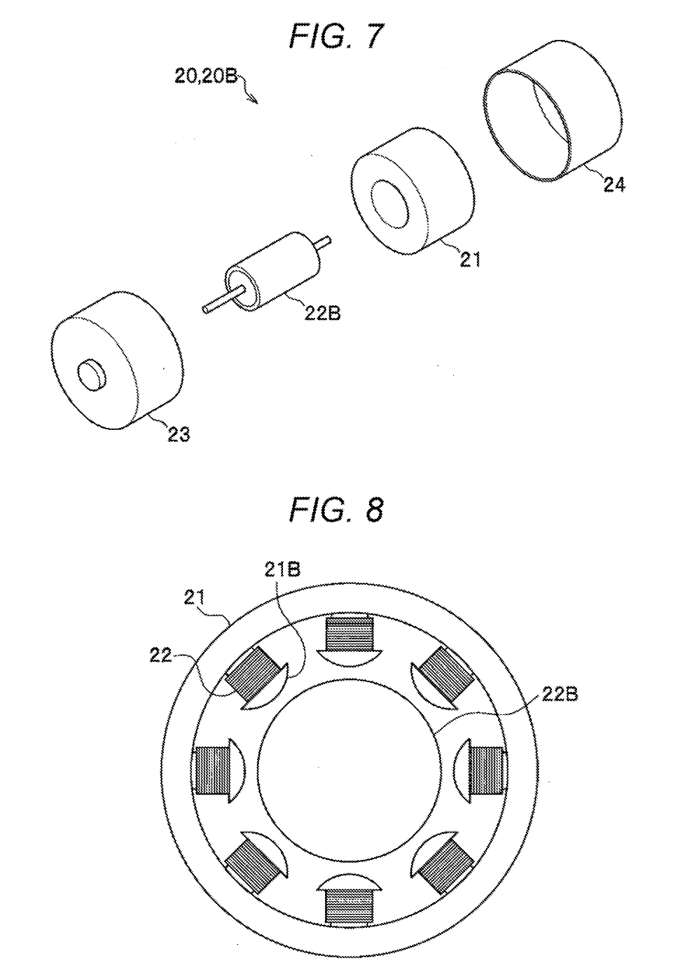

Next, the rotary electric machine according to this embodiment will be described with reference to FIGS. 5 to 8. Further, FIG. 5 is a schematic exploded view for describing an aspect of a rotary electric machine 20 according to this embodiment. FIG. 6 is a schematic cross-sectional view for describing the coil 22 which is obtained by winding the insulation wire 10 according to this embodiment around the stator illustrated in FIG. 5. FIG. 7 is a schematic exploded view for describing another aspect of the rotary electric machine 20 according to this embodiment. FIG. 8 is a schematic cross-sectional view for describing the coil which is obtained by winding the insulation wire 10 according to this embodiment around the stator illustrated in FIG. 7.

As illustrated in FIG. 5, a rotary electric machine 20A according to this embodiment includes a stator 21, a rotor 22A, a first housing 23, and a second housing 24. The rotary electric machine 20A according to this embodiment includes the rotor 22A on the outside of the stator 21, and is generally called an outer rotor type of rotary electric machine. The insulation wire 10 is wound around magnetic pole teeth 21A of the stator 21 to form the coil 22 as illustrated in FIG. 6. Then, the insulation wire 10 is welded to another insulation wire 10 or the other conductive member at an arbitrary place of the stator 21. The welded place is coated by the insulating varnish (not illustrated) not to make the conductor 11 exposed together with the insulation film 12 and the self-bonding layer 13, and cured. Further, as the insulating varnish, for example, powder varnish F-219 (made by Somar Co., Ltd.) may be used, but not limited thereto. Any insulating varnish may be used as long as the exposed portion of the conductor 11, the insulation film 12, and the self-bonding layer 13 can be coated.

The first housing 23 and the second housing 24 each are made of metal (desirably nonmagnetic metal) in a bottomed cylindrical shape. The first housing 23 and the second housing 24 are provided with the stator 21 and the rotor 22A inside the cylinder, and connected by an arbitrary fitting structure such as a welding and a screw.

The rotor 22A is provided on the outside of the stator 21, and includes a permanent magnet (not illustrated) which generates a magnetic field. The rotor 22A is supported by a bearing which is provided in the first housing 23 and the second housing 24 to be rotatable on the outside of the stator 21. Since the rotary electric machine 20A with such a configuration includes the rotor 22A on the outside of the stator 21, a large torque is easily obtained. There is an advantage that the rotation is stable in the case of a constant rotation.

In addition, as illustrated in FIG. 7, a rotary electric machine 20B according to this embodiment includes the stator 21, a rotor 22B, the first housing 23, and the second housing 24. The rotary electric machine 20B according to this embodiment includes the rotor 22B in the inside of the stator 21, and is generally called an inner rotor type of rotary electric machine. The insulation wire 10 is wound around magnetic pole teeth 21B of the stator 21 to form the coil 22 as illustrated in FIG. 8. Then, the insulation wire 10 is welded to another insulation wire 10 or the other conductive member at an arbitrary place of the stator 21. Further, the stator 21, the first housing 23, and the second housing 24 are the same as described above, and thus the description thereof will be omitted.

The rotor 22B is provided on the inside of the stator 21, and includes a permanent magnet (not illustrated) which generates a magnetic field. The rotor 22B is supported by a bearing which is provided in the first housing 23 and the second housing 24 to be rotatable on the inside of the stator 21. Since the rotary electric machine 20B with such a configuration includes the rotor 22B on the inside of the stator 21, responsiveness is excellent. Since the coil is provided on the outside, heat radiation is excellent.

In the rotary electric machine 20 (20A and 20B) according to this embodiment described above, the insulation wire 10 according to this embodiment is used for the coil 22, so that the insulation film 12 and the self-bonding layer 13 are hardly shrunk at the welded place between the insulation wires 10 or to the other conductive member, so that the insulation property can be improved. In addition, since the insulation film 12 is coated with the self-bonding layer 13 which contains the inorganic filler, the lifting-up and peeling of the insulation film 12 can be prevented even when the welding heat is transferred through the conductor 11. Further, in a case where there is a bent place in the insulation wire 10, the pressure resistance and the insulation property of the bent place can be improved since the insulation film 12 is coated with the self-bonding layer 13 which contains the inorganic filler.

### (Manufacturing Method of Insulation Wire)

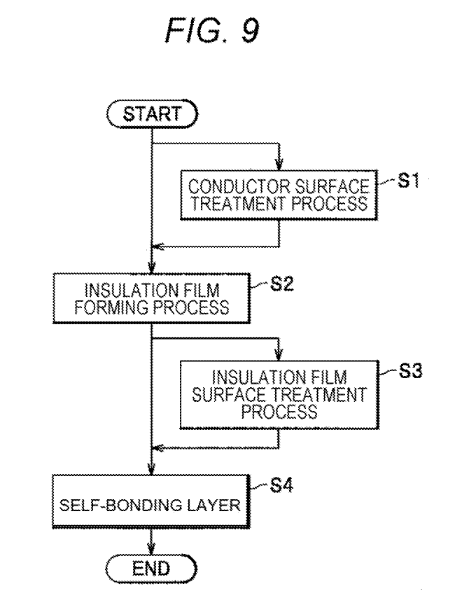

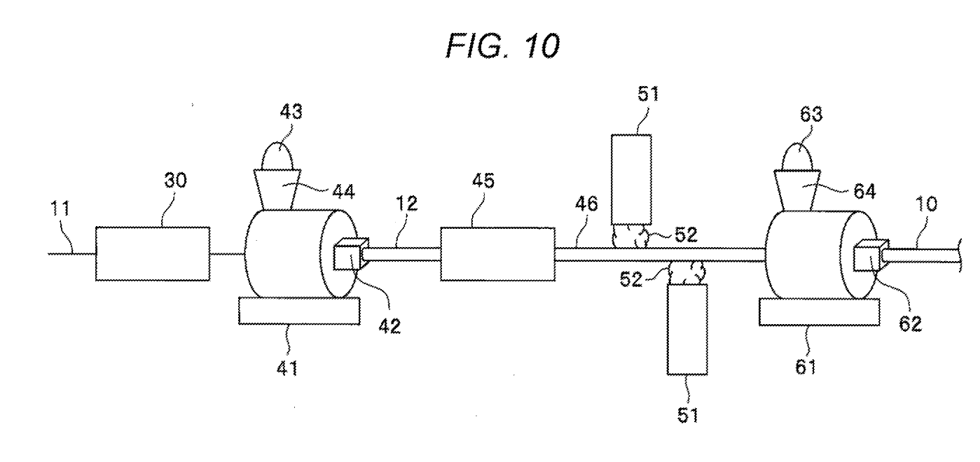

Next, a manufacturing method of the insulation wire according to this embodiment will be described with reference to FIGS. 9 and 10. Further, FIG. 9 is a flowchart for describing the manufacturing method of the insulation wire according to this embodiment. FIG. 10 is a schematic view illustrating a configuration of a manufacturing apparatus which implements the manufacturing method of the insulation wire according to this embodiment.

As illustrated in FIG. 9, the manufacturing method of the insulation wire 10 according to this embodiment includes an insulation film forming process S2 and a self-bonding layer forming process S4, and performs these processes in this order. The manufacturing method of the insulation wire 10 according to this embodiment illustrated in FIG. 9 may be performed according to the manufacturing method of the insulation wire 10 by a typical extrusion molding illustrated in FIG. 10. Hereinafter, the manufacturing method of the insulation wire 10 according to this embodiment will be described in detail.

### (Insulation Film Forming Process)

The insulation film forming process S2 is a process of forming the insulation film 12 by the extrusion molding around the conductor 11 produced in a predetermined arbitrary shape. The conductor 11 and the insulation film 12 used in the insulation film forming process S2 are equal to those described above, and the description thereof will be omitted. The insulation film forming process S2 is mainly performed using a first kneading extrusion molding machine 41 illustrated in FIG. 10. The first kneading extrusion molding machine 41 includes a cross-head die 42 which is provided with a mouse piece corresponding to the shape of the conductor 11.

A first thermoplastic resin 43 prepared in a pelletized state is inserted to a hopper/input port 44 of the first kneading extrusion molding machine 41, and supplied to a cylinder (not illustrated). The first thermoplastic resin 43 is kneaded in a melt state in the cylinder, and then supplied to the cross-head die 42.

Further, in a case where the first thermoplastic resin 43 is the resin composition, each component of the resin composition may be inserted to the hopper/input port 44 of the first kneading extrusion molding machine 41 in place of Pelletizing. In this case, each component is melt and kneaded in the cylinder to make the resin composition, and supplied to the cross-head die 42.

In the cross-head die 42, the streak conductor 11 to be the core wire passes through. The conductor 11 is obtained by the extending process in which a wire diameter is gradually reduced to a predetermined level by passing through the die. It is desirable that the conductor 11 be heated in a heating furnace 30 provided before the first kneading extrusion molding machine 41 in order to help the extending process. A heating temperature of the conductor 11 in the heating furnace 30 is desirably 300° C. for example. When passing through the cross-head die 42, the resin composition of the melt first thermoplastic resin 43 is coated to form a thin film around the conductor 11. Thereafter, the conductor 11 formed with the thin film is crystallized after passing through an electric furnace 45 and cooled down in a water bath (not illustrated) so as to form the insulation film 12 around the conductor 11. Further, in the explanation of the manufacturing method, the conductor 11 formed with the insulation film 12 so far may be called a “coated wire 46”.

### (Self-Bonding Layer Forming Process)

The self-bonding layer forming process S4 is a process of forming the self-bonding layer 13 around the insulation film 12 which is formed in the insulation film forming process S2. The self-bonding layer 13 used in the self-bonding layer forming process S4 is the same as described, and the description thereof will be omitted. The self-bonding layer forming process S4 is performed mainly using a second kneading extrusion molding machine 61 illustrated in FIG. 10. The second kneading extrusion molding machine 61 includes a cross-head die 62 which is provided with a mouse piece corresponding to the shape of the coated wire 46.

A second thermoplastic resin 63 prepared in a pelletized state is inserted to a hopper/input port 64 of the second kneading extrusion molding machine 61, and supplied to a cylinder (not illustrated). The second thermoplastic resin 63 is kneaded in a melt state in the cylinder, and then supplied to the cross-head die 62.

Further, in a case where the second thermoplastic resin 63 is the resin composition, each component of the resin composition may be inserted to the hopper/input port 64 of the second kneading extrusion molding machine 61 in place of pelletizing. In this case, each component is melt and kneaded in the cylinder to make the resin composition, and supplied to the cross-head die 62.

In the cross-head die 62, the coated wire 46 passes through. The coated wire 46 is obtained by the extending process in which a wire diameter is gradually reduced to a predetermined level by passing through the die. When passing through the cross-head die 62, the resin composition of the melt second thermoplastic resin 63 is coated to form a thin film around the coated wire 46. Thereafter, the coated wire 46 formed with the thin film is cooled down in the water bath so as to form the insulation wire 10 in which the self-bonding layer 13 is formed around the insulation film 12.

As Illustrated in FIGS. 1 and 2, the cross section of the insulation wire 10 manufactured as described above is formed such that the insulation film 12 made of the first thermoplastic resin is formed around the conductor 11 and the self-bonding layer 13 is formed around the insulation film 12.

### (Desirable Aspect of Manufacturing Method)

As a desirable aspect of the manufacturing method of the insulation wire 10 according to this embodiment, a conductor surface treatment process S1 is provided before the insulation film forming process S2 as illustrated in FIG. 9. In addition, as a desirable aspect of the manufacturing method of the insulation wire 10 according to this embodiment, an insulation film surface treatment process S3 is provided between the insulation film forming process S2 and the self-bonding layer forming process S4 as illustrated in FIG. 9. It is desirable that the conductor surface treatment process S1 and the insulation film surface treatment process S3 are performed rather than performing only any one of them. Hereinafter, a desirable aspect of these processes will be described.

### (Conductor Surface Treatment Process)

The conductor surface treatment process S1 is a process of performing a surface treatment on the surface of the conductor 11 to increase the adhesive strength of the insulation film 12. In the conductor surface treatment process S1, the surface of the conductor 11 is desirably treated using the organometallic compound for example. Therefore, the organometallic compound interposed between the surface of the conductor 11 of an inorganic material and the surface of the insulation film 12 of an organic material serves to strongly bond the two. Therefore, since the conductor 11 and the insulation film 12 are strongly bonded, the insulation film 12 is more hardly lifted up and peeled off even when the heat caused by welding is transferred through the conductor 11. As an example of such an organometallic compound, there is the silane coupling agent. When the silane coupling agent is used as the organometallic compound, the conductor 11 and the insulation film 12 can be more securely and strongly bonded. Therefore, the insulation film 12 is more hardly lifted up and peeled off even when the heat caused by welding is transferred through the conductor 11. The conductor surface treatment process S1 may be performed by a medical coating apparatus (not illustrated) in FIG. 10. As an example of the medical coating apparatus, there are a dip coater, a roll coater, a die coater, and a spray coater.

### (Insulation Film Surface Treatment Process)

The insulation film surface treatment process S3 is a process of performing a surface treatment on the surface of the insulation film 12 to increase the adhesive strength of the self-bonding layer 13. As an example of such a surface treatment, a physical roughening treatment such as oxidation treatment in which the surface of the insulation film 12 is treated using ozone or a strong acid, a chemical coupling treatment, atmospheric pressure plasma treatment, and sand blast treatment may be arbitrarily selected. As the surface treatment in the insulation film surface treatment process S3, it is desirable that the atmospheric pressure plasma treatment among these treatments be applied. In a case where the atmospheric pressure plasma treatment is applied, a plasma atmosphere may be arbitrarily selected from nitride gas, oxygen gas, and argon gas.

The insulation film surface treatment process S3 is desirably performed by a surface treatment apparatus 51 provided between the electric furnace 45 and the second kneading extrusion molding machine 61 (desirably between the water bath (not illustrated in FIG. 10) disposed after the electric furnace 45 and the second kneading extrusion molding machine 61). Further, in FIG. 10, the surface treatment apparatuses 51 are provided one by one to interpose the coated wire 46 in a vertical direction to irradiate an atmosphere pressure plasma 52, but not limited thereto. A plurality of surface treatment apparatuses 51 may be provided in parallel with the coated wire 46 to irradiate the atmosphere pressure plasma 52. In addition, the number of surface treatment apparatuses 51 may be one, or three or more. In a case where an atmospheric pressure plasma apparatus is used as the surface treatment apparatus 51, a cross-sectional shape of the nozzle which irradiates the plasma may be a circular shape or a rectangular shape.

As described above, the manufacturing method of the insulation wire 10 according to this embodiment sequentially performs at least the insulation film forming process S2 and the self-bonding layer forming process S4, so that the insulation wire 10 according to this embodiment can be manufactured.

### EXAMPLES

Next, the insulation wire according to the invention will be specifically described using examples and comparative examples, but the technical scope of the invention is not limited thereto.

The materials used in the examples and the comparative examples are as follows.

### [Materials]

First thermoplastic resin: PPS (Torelina T1881 made by Toray)
Second thermoplastic resin (1): Phenoxy resin (YP-70 made by Nippon Steel & Sumikin Chemical Co., Ltd.)
Second thermoplastic resin (2): Polyamide resin (XPA-9063X made by Ube Industries)
Cross-linking agent: Epoxy resin (EP-1011 made by Mitsubishi Chemical Corporation)
Curing agent: Phenol-based curing agent (H-4 made by Meiwa Plastic Industries Ltd.)
Curing catalyst: imidazole-based curing accelerator (2PHZ-PW made by Shikoku Chemicals Corporation)
Inorganic filler: Mica powder (A-11 made by Yamaguchi Mica Co., Ltd.)

The composition of the self-bonding layer used in the examples and the comparative examples are listed in Table 1. Further, a unit of numerical values listed in Table 1 is “part by weight”. In Table 1, “-” indicates “No containing”.

TABLE 1

| | | | | First | Second |
|---|---|---|---|---|---|
| | First | Second | Third | comparative | comparative |
| | example | example | example | example | example |
| Second | 100 | — | 60 | 100 | 100 |
| thermoplastic | | | | | |
| resin (1) | | | | | |
| Second | — | 100 | 40 | — | — |
| thermoplastic | | | | | |
| resin (2) | | | | | |
| Cross-linking | 12.5 | 12.5 | 12.5 | — | 12.5 |
| agent | | | | | |
| Curing agent | 9.4 | 12.5 | 12.5 | — | 12.5 |
| Curing catalyst | 1.3 | 1.3 | 1.3 | — | 0.63 |
| Inorganic filler | 25 | 25 | 25 | — | — |

### First Example

In a first example, Torelina T1881 was used as the first thermoplastic resin, and YP-70 (phenoxy resin) was used as the second thermoplastic resin. EP-1011 was used as the cross-linking agent, H-4 was used as the curing agent, 2PHZ-PW was used as the curing catalyst, and A-11 was used as the inorganic filler. In addition, a 1.52 mm×3.19 mm rectangular copper wire (single wire) was used as a conductor serving as the core wire.

The insulation wire according to this example was manufactured as follows. First, a conductor preheated at 300° C. in the heating furnace was passed to the cross head of the kneading extrusion molding machine to which the PPS was inserted and a PPS insulation film was formed around the conductor. At this time, a cylinder supply speed of the extrusion molding machine and a sending speed of the conductor were adjusted to make a film thickness of the insulation film equal to or more than about 100 μm. Thereafter, the insulation film was cooled down to about 130° C. by the air to accelerate the crystallization of the insulation film, and passed through the electric furnace set to 130° C.

Next, the atmospheric pressure plasma treatment (the insulation film surface treatment) was performed on the surface (that is, the surface of the insulation film) of the wire formed with the insulation film. The atmospheric pressure plasma treatment was performed using the atmosphere pressure plasma the surface treatment apparatus (FG5001) made by Plasmatreat Gmbh. The treatment was performed such that a pair of plasma irradiation nozzles connected to the apparatus was disposed to face the wire formed with the insulation film to directly expose two wide surfaces of the rectangular wire to the plasma. The nitride gas was used as the plasma atmosphere.

Next, the resin composition containing the second thermoplastic resin (1) was made at a ratio according to the first example of Table 1, and kneaded and backed using a two-shaft mixer. Then, the obtained pellets were inserted to the kneading extrusion molding machine, and the wire subjected to the atmospheric pressure plasma treatment was passed to the pellet to form the self-bonding layer around the insulation film. At this time, the cylinder supply speed of the kneading extrusion molding machine was adjusted to make the film thickness of the self-bonding layer equal to or less than 50 μm.

The obtained wire was cooled by passing through the water bath, and the insulation wire was obtained. The film thickness of the PPS insulation film in the insulation wire thus obtained was about 110 μm, and the film thickness of the phenoxy resin self-bonding layer was about 40 μm.

Subsequently, the adhesiveness between the insulation film and the self-bonding layer was confirmed using the obtained insulation wire by the following scheme to simulate the welding at the time of processing the coil. The obtained insulation wire was cut out by about 10 cm, and the insulation film 12 and the self-bonding layer 13 on one of the ends of the insulation wire 10 were cut out by about 1 cm using the electric wire stripper so as to expose the conductor 11 as illustrated in FIG. 3. Further, any wire stripper may be used. However, in this example, the electric wire stripper was used to peel off the insulation film 12 and the self-bonding layer 13 while a wire bush wheel rotated. Herein, in a case where residues of the insulation film 12 or the self-bonding layer 13 are left in the surface of the conductor 11, an adhesive failure may be caused when the sealing is performed using an insulating material again after welding. Therefore, the insulation film 12 was peeled off such that a small amount of the conductor 11 was cut out. For this reason, as illustrated in FIG. 3, the thickness of the conductor 11 in a peeled portion 14 is different from that in a portion (a non-peeled portion) where the conductor 11 is coated with the insulation film 12 and the self-bonding layer 13. Further, in the surface of the conductor 11 of the peeled portion 14, scrapes were visually confirmed which were generated by polishing when the insulation film 12 and the self-bonding layer 13 were peeled off.

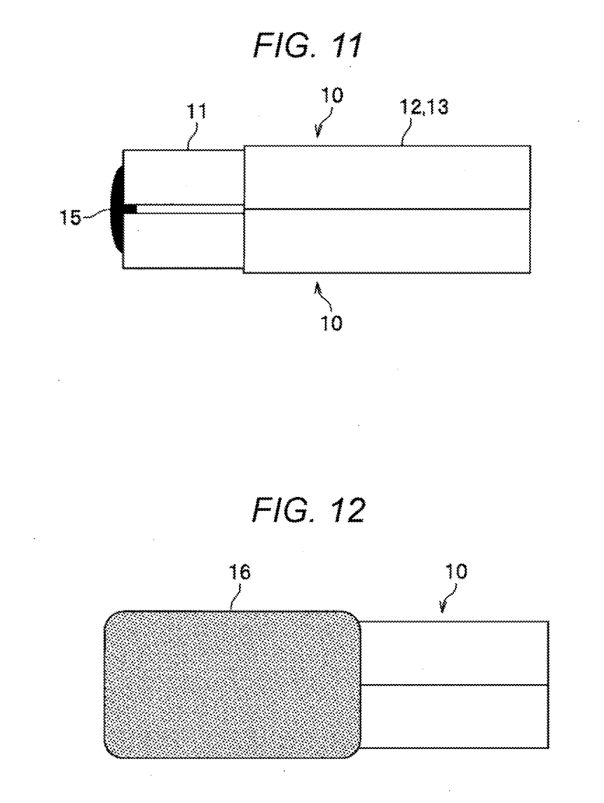

Subsequently, as illustrated in FIG. 11, the insulation wires 10 and 10 of which the conductors 11 at the end were exposed were overlapped, and the exposed conductors 11 at the end were welded by a tungsten-inactive gas welding. In this example, the welding was performed while paying attention not to heat up the insulation film 12 and the self-bonding layer 13 by a pulse welding so as to achieve a strength of a welding portion 15.

Further, when being excessively heated during the welding in the state illustrated in FIG. 11, the insulation film 12 and the self-bonding layer 13 are carbonized to be black or discolored. In such a welding condition, when the insulating varnish having a thermosetting property is coated in the exposed portion of the conductor 11 after welding, the conductor 11, the insulation film 12, and the self-bonding layer 13 are hardly bonded with the insulating varnish. Therefore, a current and a frequency at the time of welding were adjusted to perform the welding on an optimized conduction. In other words, the welding was performed on a condition that the insulation film 12 and the self-bonding layer 13 were carbonized to be black or discolored.

A state in an interface portion of the insulation wire 10 welded as described above with respect to the conductor 11, the insulation film 12, and the self-bonding layer 13 was observed. As a result, the insulation film 12 and the self-bonding layer 13 was slightly shrunk by the heat at the time of welding (see FIG. 4), but the peeling of the insulation film 12 from the conductor 11 (the lifting-up and peeling), and the peeling of the self-bonding layer 13 from the insulation film 12 (the lifting-up and peeling) were not found.

In addition, the insulation wire 10 according to the first example was measured about the distances such as the distance W1 (the distance of the exposed conductor 11) from the position P where the insulation film 12 and the self-bonding layer 13 were removed before welding to the end of the insulation film 12, and the distance W2 from the position P where the insulation film 12 and the self-bonding layer 13 were removed before welding to the end of the self-bonding layer 13 after welding (see FIG. 4). The measurement was made on both side surfaces, the upper surface, and the lower surface, and an average value was taken. As a result, it was confirmed that W1<W2 was satisfied. This relation shows that the thermal shrinkage of the self-bonding layer 13 is larger than that of the insulation film 12. As a reason, since the self-bonding layer 13 contains the curing agent having a thermosetting property and the cross-linking agent, the curing and shrinking occurs by the heat at the time of welding. However, since the self-bonding layer 13 contains the inorganic filler in this embodiment, it is considered that the distance of the curing and shrinking is shortened compared to the self-bonding layer not containing the inorganic filler. In addition, in this embodiment, the surface of the insulation film 12 is subjected to the atmospheric pressure plasma treatment to improve the adhesiveness between the insulation film 12 and the self-bonding layer 13. Therefore, it is considered that the distance of the curing and shrinking is shortened compared to the self-bonding layer not subjected to the atmospheric pressure plasma treatment. Further, the distance W1 of the exposed conductor 11 by the welding became longer than a distance W4 of the exposed insulation film 12 by the welding (W1>W4). Therefore, it was confirmed that the insulation wire 10 according to the first example was in a desirable aspect from the viewpoint of coating the insulation film 12 with the self-bonding layer 13.

Then, as illustrated in FIG. 12, insulating varnish 16 having the thermosetting property was coated and cured in the welding portion where the exposed conductor 11 (not illustrated in FIG. 12) was exposed. In this embodiment, the powder varnish F-219 (made by Somar Co., Ltd.) was used as the insulating varnish 16. The adhesiveness of the cured insulating varnish 16 with respect to the insulation film 12 and the self-bonding layer 13 (all not illustrated in FIG. 12) was peeled out by a cutter (not illustrated) for the evaluation. As a result, the insulating varnish 16 was pulverized, and part of the insulating varnish 16 was strongly bonded and left onto the insulation film 12 and the self-bonding layer 13. In other words, it was confirmed that the insulation wire 10 according to the first example was possible to strongly make the insulating varnish 16 adhere to the insulation film 12 and the self-bonding layer 13. Since the phenoxy resin used in the self-bonding layer 13 includes a hydroxyl group having a polarity in a molecular structure, the phenoxy resin has a strong interaction between molecules. As a result, it is estimated that the phenoxy resin contributes to the improvement of the adhesiveness.

As described above, it was confirmed that the insulation wire 10 according to the first example had a good adhesiveness between the insulation film 12 and the self-bonding layer 13 in a welding process which was implemented when the rotary electric machine was manufactured, and an insulation sealing process which was performed on the exposed portion of the conductor 11 thereafter. In other words, it was confirmed that the insulation film 12 did not suffer the lifting-up and peeling in the insulation wire 10 according to this example even when the heat caused by welding was transferred to the conductor 11, and the insulation property was secured.

### Second Example

The insulation wire 10 according to a second example was manufactured similarly to that of the first example except that the second thermoplastic resin (2) was used in place of the second thermoplastic resin (1) (see Table 1). Then, the welding when the coil was processed was simulated similarly to the first example using the insulation wire 10 according to the second example, and the performance of the adhesiveness between the insulation film 12 and the self-bonding layer 13 was confirmed.

As a result, it was confirmed that the insulation film 12 and the self-bonding layer 13 of the insulation wire 10 according to the second example was slightly shrunk by the heat at the time of welding (see FIG. 4). However, the peeling (the lifting-up and peeling) of the insulation film 12 from the conductor 11 and the peeling (the lifting-up and peeling) of the self-bonding layer 13 from the insulation film 12 were not found.

In addition, the insulation wire 10 according to the second example was measured about the distances such as the distance W1 (the distance of the exposed conductor 11) from the position P where the insulation film 12 and the self-bonding layer 13 were removed before welding to the end of the insulation film 12, and the distance W2 from the position P where the insulation film 12 and the self-bonding layer 13 were removed before welding to the end of the self-bonding layer 13 after welding (see FIG. 4). The measurement was made on both side surfaces, the upper surface, and the lower surface, and an average value was taken as described above. As a result, it was confirmed that the insulation wire 10 according to the second example satisfied W1<W2 similarly to the insulation wire 10 according to the first example. In addition, the distance W1 of the exposed conductor 11 by the welding became longer than a distance W4 of the exposed insulation film 12 by the welding (W1 >W4). Therefore, it was confirmed that the insulation wire 10 according to the second example was in a desirable aspect from the viewpoint of coating the insulation film 12 with the self-bonding layer 13.

Thereafter, similarly to the first example, the insulating varnish 16 was coated and cured in the welding portion where the conductor 11 was exposed (see FIG. 12). The adhesiveness of the cured insulating varnish 16 with respect to the insulation film 12 and the self-bonding layer 13 (all not illustrated in FIG. 12) was peeled out by a cutter (not illustrated) for the evaluation. As a result, the insulating varnish 16 was pulverized, and part of the insulating varnish 16 was strongly bonded and left onto the insulation film 12 and the self-bonding layer 13. In other words, it was confirmed that the insulation wire 10 according to the second example was possible to strongly make the insulating varnish 16 adhere to the insulation film 12 and the self-bonding layer 13 similarly to the insulation wire 10 according to the first example.

As described above, it was confirmed that the insulation wire 10 according to the second example had a good adhesiveness between the insulation film 12 and the self-bonding layer 13 in a welding process implemented when the rotary electric machine was manufactured, and an insulation sealing process performed on the exposed portion of the conductor 11 thereafter. In other words, it was confirmed that the insulation film 12 did not suffer the lifting-up and peeling in the insulation wire 10 according to this example even when the heat caused by welding was transferred to the conductor 11, and the insulation property was secured.

### Third Example

The insulation wire 10 according a third example was manufactured similarly to that of the first example except that the second thermoplastic resin (1) and the second thermoplastic resin (2) each were used by a predetermined amount (see Table 1). Then, the welding when the coil was processed was simulated similarly to the first example using the insulation wire 10 according to the third example, and the performance of the adhesiveness between the insulation film 12 and the self-bonding layer 13 was confirmed.

As a result, it was confirmed that the insulation film 12 and the self-bonding layer 13 of the insulation wire 10 according to the third example was slightly shrunk by the heat at the time of welding (see FIG. 4). However, the peeling (the lifting-up and peeling) of the insulation film 12 from the conductor 11 and the peeling (the lifting-up and peeling) of the self-bonding layer 13 from the insulation film 12 were not found.

In addition, the insulation wire 10 according to the third example was measured about the distances such as the distance W1 (the distance of the exposed conductor 11) from the position P where the insulation film 12 and the self-bonding layer 13 were removed before welding to the end of the insulation film 12, and the distance W2 from the position where the insulation film was removed before welding to the end of the self-bonding layer 13 after welding (see FIG. 4). The measurement was made on both side surfaces, the upper surface, and the lower surface, and an average value was taken as described above. As a result, it was confirmed that the insulation wire 10 according to the third example satisfied W1<W2 similarly to the insulation wire 10 according to the first example. Further, the distance W1 of the exposed conductor 11 by the welding became longer than a distance W4 of the exposed insulation film 12 by the welding (W1 >W4). Therefore, it was confirmed that the insulation wire 10 according to the third example was in a desirable aspect from the viewpoint of coating the insulation film 12 with the self-bonding layer 13.

Thereafter, similarly to the first example, the insulating varnish 16 was coated and cured in the welding portion where the conductor 11 was exposed (see FIG. 12). The adhesiveness of the cured insulating varnish 16 with respect to the insulation film 12 and the self-bonding layer 13 (all not illustrated in FIG. 12) was peeled out by a cutter (not illustrated) for the evaluation. As a result, the insulating varnish 16 was pulverized, and part of the insulating varnish 16 was strongly bonded and left onto the insulation film 12 and the self-bonding layer 13. In other words, it was confirmed that the insulation wire 10 according to the third example was possible to strongly make the insulating varnish 16 adhere to the insulation film 12 and the self-bonding layer 13 similarly to the insulation wire 10 according to the first and second examples.

In addition, the insulation wire 10 according to the third example (a length of about 60 cm) was formed in a U shape by an edge wising. At this time, the insulation wire was bent by 180 degrees using a pin of 2.0 mmφ. An aluminium foil was wound in a bent portion of the U-shaped insulation wire 10, and an electrode was provided. Further, an electrode was provided even on the other end of the U-shaped insulation wire 10, and a breakdown voltage (BDV) was measured. As a result, the BDV of the bent portion of the insulation wire 10 was lowered by 12% compared to that before the bending, but it was confirmed that the BDV was equal to or more than 10 kV. Further, it was confirmed that a variation was less every sample, and the insulation property was good.

As described above, it was confirmed that the insulation wire 10 according to the third example had a good adhesiveness between the insulation film 12 and the self-bonding layer 13 in a welding process implemented when the rotary electric machine was manufactured, and an insulation sealing process performed on the exposed portion of the conductor 11 thereafter. In other words, it was confirmed that the insulation film 12 did not suffer the lifting-up and peeling in the insulation wire 10 according to this example even when the heat caused by welding was transferred to the conductor 11, and the insulation property was secured. In addition, it was confirmed that the insulation wire 10 according to the third example had a good insulation property in the bent portion. It is considered that the good insulation property in the bent portion of the insulation wire 10 according to the third example is because that the self-bonding layer 13 contains the inorganic filler. Therefore, it is expected that the insulation property in the bent portion is good similarly even to the insulation wire 10 according to the first and second examples.

### First Comparative Example

The insulation wire according to a first comparative example was manufactured similarly to that of the first example except that the second thermoplastic resin (1) did not contain the cross-linking agent, the curing agent, the curing catalyst, and the inorganic filler, and the atmospheric pressure plasma treatment was not performed (see Table 1). Then, the welding when the coil was processed was simulated similarly to the first example using the insulation wire according to the first comparative example, and the performance of the adhesiveness between the insulation film and the self-bonding layer was confirmed.

As a result, it was confirmed that the insulation film and the self-bonding layer of the insulation wire according to the first comparative example was shrunk by the heat at the time of welding similarly to the first to third examples (see FIG. 4). However, the peeling (the lifting-up and peeling) of the insulation film from the conductor and the peeling (the lifting-up and peeling) of the self-bonding layer from the insulation film were not found. However, it was confirmed that the self-bonding layer of the insulation wire according to the first comparative example was cracked near the end, and the coating property (adhesiveness) to the insulation film was worsened. As a reason that the self-bonding layer of the insulation wire according to the first comparative example was cracked, a low strength of the thin film can be given since the self-bonding layer did not contain the inorganic filler. In addition, since the atmospheric pressure plasma treatment (the insulation film surface treatment) is not performed, a low adhesiveness between the insulation film and the self-bonding layer can be given.

In addition, as illustrated in FIG. 4, the insulation wire according to the first example was measured about the distances such as the distance W1 (the distance of the exposed conductor 11) from the position P where the insulation film 12 and the self-bonding layer 13 were removed before welding to the end of the insulation film 12, and the distance W2 from the position P where the insulation film 12 and the self-bonding layer 13 were removed before welding to the end of the self-bonding layer 13 after welding. The measurement was made on both side surfaces, the upper surface, and the lower surface, and an average value was taken. As a result, it was confirmed that the insulation wire according to the first comparative example satisfied W1<W2 similarly to the insulation wire 10 according to the first example. However, since the length of the distance W2 became long compared to that of the first to third example, and there were many places in the insulation film 12 were not coated with the self-bonding layer 13. As a reason, it is considered because the self-bonding layer 13 did not contain the inorganic filler. In addition, the fact that the atmospheric pressure plasma treatment was not performed on the surface of the insulation film 12 is also considered as an influence. Further, the distance W1 of the conductor 11 exposed by the welding and the distance W4 of the insulation film 12 exposed by the welding were substantially equal (W1≠W4). Therefore, it was confirmed that the insulation wire according to the first comparative example was an undesirable aspect from the viewpoint of coating the insulation film 12 with the self-bonding layer 13.

In addition, thereafter, the insulating varnish 16 of the thermosetting property was coated and cured in the welding portion where the conductor was exposed similarly to the first example (see FIG. 12). Then, the adhesiveness of the cured insulating varnish 16 with respect to the insulation film and the self-bonding layer of the insulation wire 10 (all not illustrated in FIG. 12) was peeled out by a cutter for the evaluation. As a result, the insulating varnish 16 was pulverized, and part of the insulating varnish 16 was slightly left in the insulation film and the self-bonding layer. However, the slightly left insulating varnish 16 was also easily peeled off. As a primary reason, it is considered that the self-bonding layer did not contain the inorganic filler, and thus the heat caused by welding was transferred to cause the curing and shrinking and to expose the insulation film much. In other words, the adhesiveness between the insulation film and the insulating varnish is not good so much, and thus it is considered that the insulating varnish is easily peeled off from the insulation film and the self-bonding layer by increasing a contact surface between the insulation film and the insulating varnish. In addition, since the surface of the insulation film was not subjected to the atmospheric pressure plasma treatment, it is considered as one of causes that the adhesiveness between the self-bonding layer and the insulation film using the PPS was not good. In other words, the adhesiveness between the insulating varnish and the self-bonding layer using the phenoxy resin was good, and on the contrary the adhesiveness between the self-bonding layer and the insulation film of which the surface was not subjected to the atmospheric pressure plasma treatment was not good as described above, so that it is considered that the insulating varnish was not peeled off from the insulation film unlike the self-bonding layer.

Further, similarly to the third example, the insulation wire having a length of about 60 cm was made in the U shape by the edge wising. At this time, the insulation wire was bent by 180 degrees using a pin of 2.0 mmφ). An aluminium foil was wound in a bent portion of the U-shaped insulation wire, and an electrode was provided. Further, an electrode was provided even on the other end of the U-shaped insulation wire, and the BDV was measured. As a result, the BDV of the bent portion of the insulation wire was less than 10 kV, and it was confirmed that a variation for each sample was increased and the insulation property was not good.

As described above, it was confirmed that the insulation wire according to the first comparative example had a problem in adhesiveness between the insulation film and the self-bonding layer in the welding process which was implemented when the rotary electric machine was manufactured, and the insulation sealing process which was performed on the exposed portion of the conductor thereafter. In addition, it was confirmed that the insulation property of the insulation wire according to the first comparative example was not good.

### Second Comparative Example

The insulation wire according to a second comparative example was manufactured similarly to that of the first example except that the second thermoplastic resin (1) did not contain the inorganic filler, and the atmospheric pressure plasma treatment was not performed (see Table 1). Then, the welding when the coil was processed was simulated similarly to the second example using the insulation wire according to the first comparative example, and the performance of the adhesiveness between the insulation film and the self-bonding layer was confirmed.

As a result, it was confirmed that the insulation film and the self-bonding layer of the insulation wire according to the second comparative example was shrunk by the heat at the time of welding similarly to the first to third examples (see FIG. 4). However, the peeling (the lifting-up and peeling) of the insulation film from the conductor and the peeling (the lifting-up and peeling) of the self-bonding layer from the insulation film were not found.

In addition, as illustrated in FIG. 4, the insulation wire according to the second example was measured about the distances such as the distance W1 (the distance of the exposed conductor 11) from the position P where the insulation film 12 and the self-bonding layer 13 were removed before welding to the end of the insulation film 12, and the distance W2 from the position P where the insulation film 12 and the self-bonding layer 13 are removed before welding to the end of the self-bonding layer 13 after welding. The measurement was made on both side surfaces, the upper surface, and the lower surface, and an average value was taken. As a result, it was confirmed that the insulation wire according to the second comparative example satisfied W1<W2 similarly to the insulation wire 10 according to the first example. However, since the length of the distance W2 became long compared to that of the first to third example and the first comparative example, and there were many places in the insulation film 12 were not coated with the self-bonding layer 13. As a reason, it is considered that the self-bonding layer 13 contained the cross-linking agent (the thermosetting resin, the thermosetting monomer) and the curing and shrinking occurred easily, but not contained the inorganic filler. In addition, the fact that the atmospheric pressure plasma treatment was not performed on the surface of the insulation film 12 is also considered as an influence. Further, the distance W4 of the insulation film 12 exposed by the welding were longer than the distance W1 of the conductor 11 exposed by the welding (W1<W4). Therefore, it was confirmed that the insulation wire according to the second comparative example was an undesirable aspect from the viewpoint of coating the insulation film 12 with the self-bonding layer 13.

In addition, thereafter, the insulating varnish 16 of the thermosetting property was coated and cured in the welding portion where the conductor was exposed similarly to the first example (see FIG. 12). Then, the adhesiveness of the cured insulating varnish 16 with respect to the insulation film and the self-bonding layer of the insulation wire 10 (all not illustrated in FIG. 12) was peeled out by a cutter for the evaluation. As a result, the insulating varnish 16 was pulverized, and part of the insulating varnish 16 was slightly left in the insulation film and the self-bonding layer. However, the slightly left insulating varnish 16 was also easily peeled off. It is considered that the reason is the same as that of the first comparative example.

Further, similarly to the third example, the insulation wire having a length of about 60 cm was made in the U shape by the edge wising. At this time, the insulation wire was bent by 180 degrees using a pin of 2.0 mmφ. An aluminium foil was wound in a bent portion of the U-shaped insulation wire, and an electrode was provided. Further, an electrode was provided even on the other end of the U-shaped insulation wire, and the BDV was measured. As a result, the BDV of the bent portion of the insulation wire was less than 10 kV, and it was confirmed that a variation for each sample was increased and the insulation property was not good.

As described above, it was confirmed that the insulation wire according to the second comparative example had a problem in adhesiveness between the insulation film and the self-bonding layer in the welding process which was implemented when the rotary electric machine was manufactured, and the insulation sealing process which was performed on the exposed portion of the conductor thereafter. In addition, it was confirmed that the insulation property of the insulation wire according to the second comparative example was not good in the bent portion.

Hitherto, the manufacturing method of the insulation wire, the rotary electric machine, and the insulation wire have been described in detail using the embodiments and the example, but the invention is not limited to the embodiments to the examples. The various modification may be included. For example, the embodiments and the examples are described in a clearly understandable way for the invention, and thus the invention is not necessarily to provide all the configurations described above. In addition, some configurations of a certain embodiment or example may be replaced with the configurations of another embodiment or example, and the configuration of the other embodiment or example may also be added to the configuration of a certain embodiment or example. Furthermore, additions, omissions, and substitutions may be made on some configurations of each embodiment and example using other configurations.

What is claimed is:

1. An insulation wire, comprising:
a conductor of any shape;
an insulation film made of a first thermoplastic resin that is formed around the conductor; and
a self-bonding layer made of a second thermoplastic resin that is formed around the insulation film and has a self-bonding property,
wherein the first thermoplastic resin contains at least one of polyphenylene sulfide and polyether ether ketone, and
wherein the second thermoplastic resin contains a thermosetting resin and an inorganic filler.

2. The insulation wire according to claim 1,
wherein the second thermoplastic resin contains at least one of a phenoxy resin and a polyamide resin.

3. The insulation wire according to claim 1,
wherein the inorganic filler is formed in at least one of a plate shape and a squamous shape.

4. The insulation wire according to claim 1,
wherein a thermal shrinkage of the insulation film is smaller than that of the self-bonding layer.

5. A rotary electric machine, comprising:
an insulation wire that includes
a conductor of any shape,
an insulation film made of a first thermoplastic resin that is formed around the conductor, and
a self-bonding layer made of a second thermoplastic resin that is formed around the insulation film and has a self-bonding property,
wherein the first thermoplastic resin contains at least one of polyphenylene sulfide and polyether ether ketone, and
wherein the second thermoplastic resin contains a thermosetting resin and an inorganic filler; and
a rotor or a stator to which the insulation wire is wound.

6. The rotary electric machine according to claim 5, wherein
in a welding portion between the insulation wires or between the insulation wire and another conductive member,
a distance W1 from a position where the insulation film and the self-bonding layer are removed before welding to an end of the insulation film after welding is smaller than a distance W2 from the position where the insulation film and the self-bonding layer are removed before welding to an end of the self-bonding layer after welding.

7. A manufacturing method of an insulation wire that includes
a conductor of any shape,
an insulation film made of a first thermoplastic resin that is formed around the conductor, and
a self-bonding layer made of a second thermoplastic resin that is formed around the insulation film and has a self-bonding property,
wherein the first thermoplastic resin contains at least one of polyphenylene sulfide and polyether ether ketone, and
wherein the second thermoplastic resin contains a thermosetting resin and an inorganic filler,
the method, comprising:
forming the insulation film around the conductor made of any shape by an extrusion molding; and
forming the self-bonding layer around the insulation film.

8. The manufacturing method of the insulation wire according to claim 7, further comprising:
performing conductor surface treatment on a surface of the conductor to increase an adhesive strength of the insulation film before the forming the insulation film.

9. The manufacturing method of the insulation wire according to claim 8,
wherein the surface treatment to increase the adhesive strength of the insulation film is performed using an organometallic compound.

10. The manufacturing method of the insulation wire according to claim 9,
wherein the organometallic compound is a silane coupling agent.

11. The manufacturing method of the insulation wire according to claim 7, further comprising:
performing insulation film surface treatment on a surface of the insulation film to increase an adhesive strength of the self-bonding layer between the forming of the insulation film and the forming of the self-bonding layer.

12. The manufacturing method of the insulation wire according to claim 11,
wherein the surface treatment to increase the adhesive strength of the self-bonding layer is at least one of atmospheric pressure plasma treatment, oxidation treatment, coupling treatment, and sand blast treatment.
